(19) United States
(12) Patent Application Publication
(10) Pub. No.: US 2016/0050541 A1
(43) Pub. Date: Feb. 18, 2016

(54) Fine-Grained Indoor Location-Based Social Network

(71) Applicant: Egypt-Japan University of Science and Technology, Alexandria (EG)

(72) Inventors: Moustafa Amin Youssef, Alexandria (EG); Moustafa Mahmoud Elhamshary, Tanta (EG)

(73) Assignee: EGYPT-JAPAN UNIVERSITY OF SCIENCE AND TECHNOLOGY, Alexandria (EG)

(21) Appl. No.: 14/724,893

(22) Filed: May 29, 2015

Related U.S. Application Data
(60) Provisional application No. 62/004,559, filed on May 29, 2014.

(51) Int. Cl. H04W 4/04; G06F 17/30; H04W 4/02

(52) U.S. Cl. CPC H04W 4/043; H04W 4/027; G06F 17/30528; G06F 17/3053; G06F 17/30241; G06F 17/30867; G06F 17/30554; H04W 84/12

(57) ABSTRACT

A system for providing a fine-grained indoor location-based social network (LBSN), the invention leverages the crowd-sensed data collected from a plurality of users' mobile devices during the check-in operation and knowledge extracted from current LBSNs to associate a place with its name and semantic fingerprint. This semantic fingerprint is used to obtain a more accurate list of nearby places as well as automatically detect new places with similar signatures. A novel algorithm for handling incorrect check-ins and inferring a semantically-enriched floorplan is proposed as well as an algorithm for enhancing the system performance based on the user implicit feedback.

### RELATED APPLICATIONS

This application claims the benefit of U.S. Provisional Application No. 62/004,559, filed May 28, 2014.

### FIELD OF THE INVENTION

This invention relates to the field of location-based services, and more specifically to a system providing an indoor location-based social network.

### BACKGROUND OF THE INVENTION

One of the main functionalities of a LBSN is the check-in operation, where the user is presented with a ranked list of nearby venues to choose his current location. With the limited screen size of mobile phones, accurate ranking of location-based query results becomes crucial as the user would find it hard to scroll beyond the top few results. To tackle the venues ranking problem in LBSNs, approaches either rely on experts to evaluate the places, rely on the review of all users that visited this place previously, rank places based on the closest distance to the estimated user location, or based on location popularity. Regardless of the ranking algorithm used, this ranking operation usually depends on accurate localization of the mobile phone user for better efficiency and accuracy in location queries. However, traditional LBSNs localization techniques depend on the GPS and/or network-based localization. Consequently, current LBSNs provide reasonable accuracy only for outdoor environments or entire buildings.

On the other hand, in indoor environments, GPS may not be available and the accuracy of cellular-based approaches range from a few hundred meters to kilometers. Even when WiFi is turned on (e.g. using Google My Location), while the median distance error in estimating the actual venue location is 84 m, which is still coarse-grained for indoor environments. This leads to an inaccurate ranked list of nearby venues. Such inaccuracy leads to a worse user experience, which in turn is reflected on the accuracy of the collected data and business value. With the fact that users spend about 89% of their time indoors, this sparks the need for a new LBSN that can work well in indoor environments.

Directly extending current LBSNs to use an accurate indoor location determination technique from literature does not solve the problem since there are a number of challenges that need to be addressed to have a truly fine-grained indoor LBSN; Specifically, all indoor localization techniques that leverage smart phones sensors, including WiFi, have an average localization error in the range of few meters. This error in localization can lead to placing the user on the other side of the wall in a completely different venue. Moreover, users may select an incorrect place to check-in either intentionally or accidentally. These errors lead to problems in venues ranking and labelling. Furthermore, the system needs to be energy-efficient to avoid phone battery drainage. Finally, and most importantly, an indoor LBSN should learn the labels of indoor locations automatically to answer nearest-location queries efficiently and accurately. This cannot be done manually for scalability reasons and due to the inaccuracies of user check-ins and location.

### SUMMARY OF THE INVENTION

To overcome the shortcomings of the prior art and to provide user location determination with greater accuracy, the presented invention provides a system to provide a fine grained indoor location based service.

When a user issues a check-in request, a client 10 on the user's device collects information from one or more sensors 100. Access to sensors 100 is controlled in accordance with a data collection policy configured in the user Privacy Profile, and forwards them to the a cloud server 20. Sensors 100 used are either low-energy sensors (e.g. inertial sensors), sensors that are already used for other purposes (e.g. cellular information), and/or sensors that are used opportunistically if the user turned them on for other purposes (e.g. WiFi, camera, mic). In the event a GPS signal is available, the GPS signal may be used as well. At the heart of the system is an indoor localization technology.

An indoor localization technology uses a dead-reckoning approach to estimate the user location based on the phone inertial sensors. To reset the error accumulation, it leverages points in the environment that have unique signatures. For example, a user taking the elevator will have a unique acceleration pattern, which can be used to know that the user is currently located in the elevator. One such indoor localization technology is the Unloc system which is preferred due to its high accuracy, low-energy consumption, and its reliance only on the phone sensors.

Using the reported phone location, even with a coarse-grained accuracy, a Venues Database Manager module 106 contacts traditional LBSNs, e.g. Foursquare, to obtain a list of nearby venues and their associated information (e.g. pictures and popularity). These candidate venues are combined with the list of nearby venues already stored in the a local venues database 112 and the merged list is annotated with the multi-sensor fingerprint of each venue stored in venues database 112.

The current invention comprises the following main functionalities: privacy controller, fingerprint preparation, venues ranking, user feedback, and semantic labelling of the floorplan.

As privacy is an important issue in the design of mobile sensing applications, the system gives users full control over their own sensed data by means of a personalized privacy configuration. The system has different modes of operations (full sensor collection, privacy insensitive data only) that tailor the amount of data collected based on the user's preferences. There is a trade-off between the performance of the system and privacy. Local processing of the collected privacy-sensitive sensors on the user's device can further enhance the user privacy.

Fingerprint Preparation module 114 is responsible for preparing the test fingerprint for the venue the user is currently located at as well as retrieving the fingerprints for candidate venues from the venues database 112.

Venues Ranking module 108 is responsible for ranking the candidate list generated by Venues Database Manager 106. It accomplishes this by three main components (blue in FIG. 3): filtering, feature-based ranking, and rank aggregation.

User Feedback module 116 provides a significant characteristic of the users' interaction with a LBSN, that is, the user can explicitly select a venue to check-in from the list of nearby venues, which acts as the “ground truth” for the user current venue. This feedback not only provides information about the performance of the venues ranking algorithm, but it also can improve the system performance by identifying which ranker provides the best performance.

Semantic Floorplan Labelling module 118 is responsible for the automatic labelling of the venue names on the floorplan. The system starts with a floorplan with shops and corridors highlighted which can be either manually uploaded or automatically generated from crowdsourced data.

### BRIEF DESCRIPTION OF THE DRAWINGS

FIG. 1 shows one implementation of the system architecture of the present invention.

FIG. 2 is a graph showing performance of filters for different venues.

FIG. 3 is a graph showing performance of the different rankers

FIG. 4A is a graph showing evaluation of the user feedback module with weight evolution of different rankers starting from equal weights.

FIG. 4B is a graph showing evaluation of the user feedback module with the CDF of the rank of the actual venue in final list.

FIG. 5 is a graph showing the ability to correctly label venues on the floorplan for different values of check-in errors (pe) for different detectors.

FIG. 6 is a graph showing the CDF of actual venues ranking for different modes of operations of the system of the present invention.

### DETAILED DESCRIPTION OF THE INVENTION

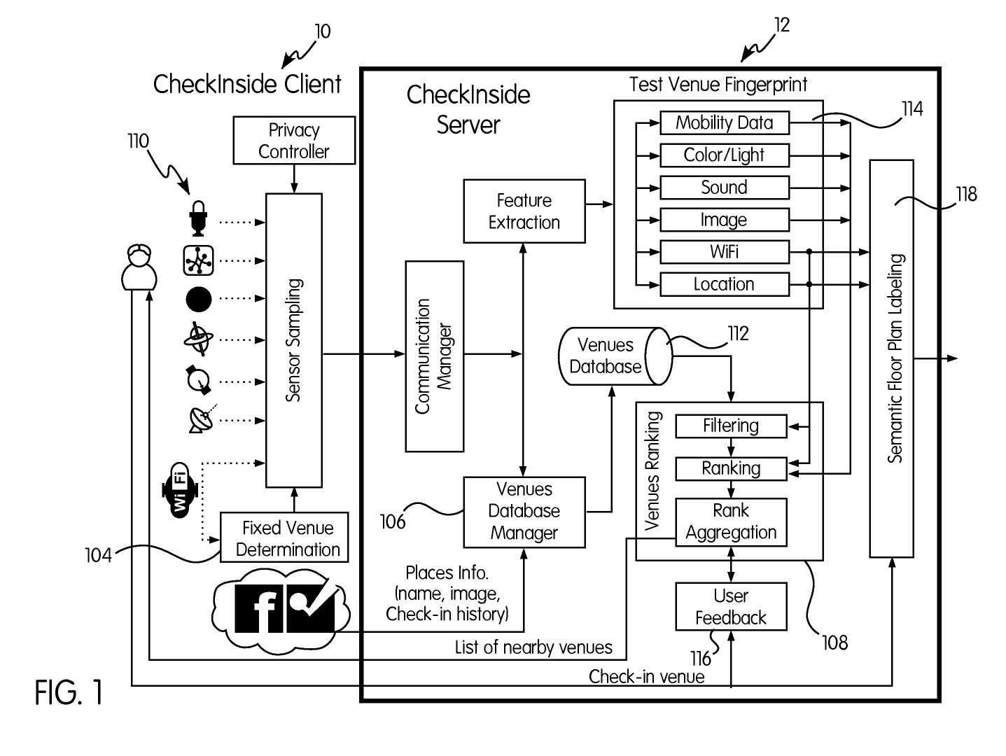

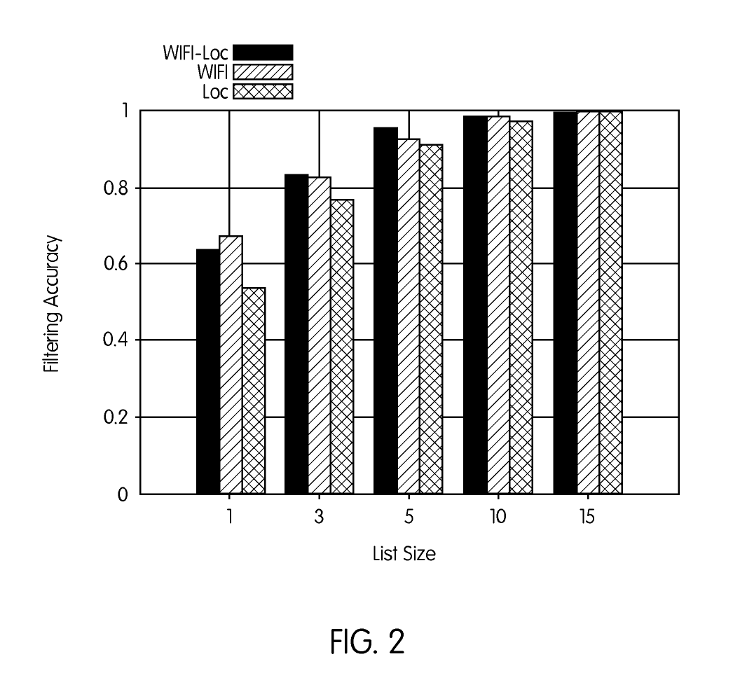

Referring to FIG. 1, the current invention (known commercially as Checklnside™) comprises the following main components: privacy controller, fingerprint preparation, venues ranking, user feedback, and semantic labelling of the floorplan.

Privacy Controller—As privacy is an important issue in the design of mobile sensing applications, the system, through privacy controller 102, gives users full control over their own sensed data by means of a personalized privacy configuration. The system has different modes of operations (full sensor collection, privacy insensitive data only) that tailor the amount of data collected based on the user's preferences. There is a trade-off between the performance of the system and privacy. Local processing of the collected privacy-sensitive sensors on the user's device can further enhance the user privacy.

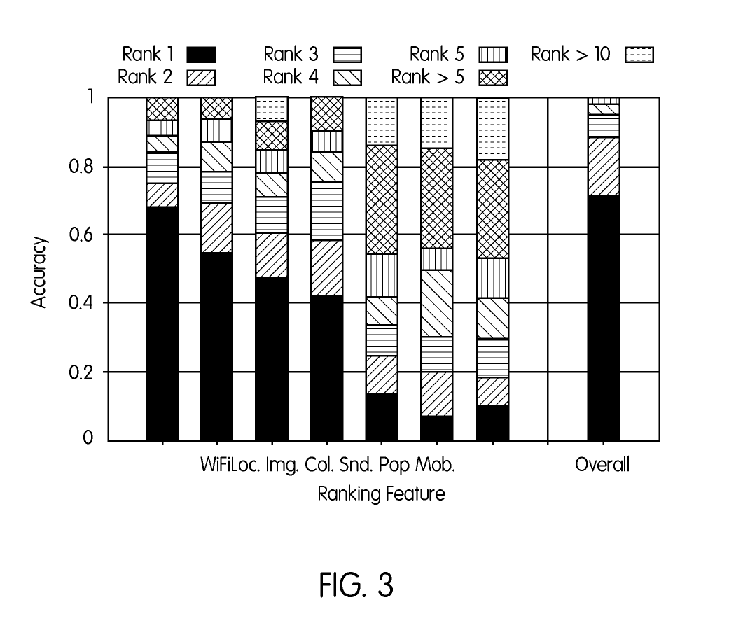

Fingerprint Preparation—This module is responsible for preparing the test fingerprint for the venue where the user is currently located, as well as retrieving the fingerprints for candidate venues from the venues database. It consists of three main modules (green modules in FIG. 3):

Fixed Venue Determination module 104—To reduce energy consumption and enhance the user privacy, fixed venue determination module 104 determines if the user is stationary at the same venue for a pre-determined period of time to start collecting data from the sensors, as explained below. Because the estimated indoor location may have inherent errors that may place the user, for example, at the wrong side of a wall (i.e. in another venue), it is able to use WiFi similarity for determining whether or not a user is stationary within a venue, which has been shown in literature to give better performance. In particular, the system considers that a user is staying at the same venue if the similarity of consequently received signal strength from WiFi access points (APs) is larger than a certain threshold. We experimented with different similarity functions and found that the best results are obtained as follows. Specifically, given two lists of APs at two locations (AP_{S1}) and AP_{S2}), the similarity is given as:

$$s = \frac{1}{\vert {AP}_{{s}_{u}} \vert} {\sum }_{a ∈ {AP}_{{s}_{u}}} ( {f}_{1} ( a ) + {f}_{2} ( a ) ) \frac{min ( {f}_{1} ( a ) , {f}_{2} ( a ) )}{max ( {f}_{1} ( a ) , {f}_{2} ( a ) )} \qquad ( 1 )$$

where APₛ_{ᵤ} is the union of the MAC addresses of the APs in the two locations, and f₁ (a) and f₂(a) are the fraction of times each unique MAC address a was observed over all recordings in the two locations respectively. Once the user is detected to be stationary, sensor data as well as stay duration information, are collected. When the user performs a check-in operation, this sensor information is piggy-backed with the check-in request to the server.

The venues data base manager module 106 prepares a list of the candidate venues that will be further ranked by venues ranking module 108. It first consults a location database (in the preferred embodiment, the Foursquare database) to retrieve the list of nearby venues given the current user location. Other data retrieved from the location database includes the pictures associated with the venue, check-in history, and location. It then stores/updates this data in a local database 112 and retrieves the associated multi-sensor fingerprint of the retrieved list as well as the location of the venues as estimated by the system, if the venue already exists in the database.

Feature Extraction Module 110 extracts the features used to characterize a certain venue to generate, using module 114, the test fingerprint of the location the user is currently at and is used later by venues ranking module 108. Features extracted cover both the user's behavior as well as surrounding environment. Specifically, the following features are used:

Location: This is based on the Unloc system that performs dead-reckoning and leverages points in the environment with unique sensor signatures (e.g. elevators, turns, etc) to reset the accumulated error. Unloc has the advantages of not requiring any calibration or infrastructure, high accuracy, and low energy consumption.

Mobility data: This group of features captures users' behavior while visiting different venues. For example, people are stationary for a longer time in restaurants and they mostly visit them during a certain time of day (i.e., meal times). On the other hand, users are more mobile in clothing shops and there is no fixed pattern for the visiting time of this category.

The system uses three mobility features to characterize the nature of venue: (1) the user activity in the venue, (2) the time of day this type of venue is usually visited, and (3) the time users spend in this venue.

The first feature, the user activity, is defined as the ratio (r) between the user mobility time to user stationary time within a certain period. This is quantized into three levels: stationary (e.g. sitting in a restaurant, if r<0:2), browsing (e.g. in a clothing shop, if 0.2<r≦2), and walking (e.g. in a grocery store, if r>2).

Visiting time is quantized into different periods: early morning, late morning, early afternoon, late afternoon, early evening, and late evening.

Finally, stay duration is quantized into 30 minute intervals.

The fingerprint associated with the three mobility features is the histogram of the feature samples collected at this particular venue from different check-ins. The stay duration information is not available from the current LBSNs as they only store the check-in time.

WiFi Fingerprint: Due to the limited range of WiFi in indoor environments, it can be used to characterize venues indoors. The system stores the fraction of times each unique MAC address was observed in the venue over all check-ins as the fingerprint for a specific venue.

Sound Fingerprint: Sound captured by a mobile device's microphone is a rich source of information that can be used to make accurate inferences about the surrounding environment. To recognize venues using ambient sound, the system derives a fingerprint for the venue based on the signal amplitude to capture the loudness of the sound in the venue. Specifically, the amplitude is divided into 100 equal intervals and the number of samples per interval is normalized by the total number of samples in the recording. The 100 normalized values are considered to be features of the ambient environment. Since sound from the same venue can vary over time, the day is divided into 24 1-hour bins and uses a separate sound fingerprint for each bin.

Image Fingerprint: There are many features used in literature to represent images including the Scale-Invariant Features Transform (SIFT) which captures the local features in image and gist features which capture the scene features in an image. While these features capture essential characteristics of images, they are not directly appropriate for our system due to their large size. For instance, each SIFT feature is a 128 dimensional vector and there are several hundred of such SIFT vectors for an image. The large size makes it inefficient in image matching, which is not suitable for the real-time operation required by the present invention.

To resolve this problem, the visterms compact features is leveraged which reduce the size of the SIFT features significantly by efficient clustering. A visterm is treated as a term in a document (image in our case) which has an inverse document frequency (IDF) to indicate its discriminative power.

### Color/Light Fingerprint:

The system extracts dominant colors and light intensity from pictures of floors and walls by transforming the pixels of the floor images from the RGB space to the hue-saturation-lightness (HSL) space. This has the advantages of removing the effect of shadows of objects and people, and the reflections of light; and decoupling the floor and wall colors from the ambient light intensity.

The K-means clustering algorithm was run on the HSL image representation of all pictures taken at the same venue. The K-means algorithm divides the pixels into K clusters, such that the sum of distances from all pixels to their centroid is minimized. The centroids of these clusters, as well as the cluster sizes, together form the color/light fingerprint of that venue.

Popularity: Popularity indicates the number of check-ins for a certain venue. This feature is extracted from the location database data and is used in the ranking process to favor popular venues.

### Venues Ranking Module

Referring to FIG. 1, this component is responsible for ranking the candidate list generated by venues database manager 106. It accomplishes this by three main components (blue in FIG. 1): filtering, feature-based ranking, and rank aggregation:

### Filtering

The function of filtering component 108a is to eliminate candidate venues that are not likely to be similar to the test venue. This helps in increasing the efficiency and accuracy of the next ranking modules. Filtering is performed based on the current user location and the WiFi fingerprint. Both filters are run independently and concurrently returning a number of candidate venues. To avoid excessive filtering, this module returns a fixed number of locations.

Filtering By Location: This is performed by placing a threshold on the distance between the current user location and the candidate venue location. The metric used for distance calculation is the shortest door-to-door walking distance, rather than the Euclidian distance. The walking distance is estimated as the shortest distance between two points on a floorplan. To speed up this filtering operation, an R-tree to index the venues database is used.

Filtering By WiFi Fingerprint: WiFi-based filtering is performed by computing the similarity between the test venue WiFi fingerprint and all candidate venues WiFi fingerprints using Eq. 1 and then returning the venues with the highest scores.

### Feature-Based Ranking

Ranking module 108b orders candidate venues according to their pairwise similarity with the test venue. Each ranker orders the pruned list of nearby venues received from the filtering component based on one of the features in parallel.

Sound ranker: To compute the degree of similarity between two sound fingerprints, the Euclidean distance between the corresponding sound fingerprint vectors is used.

Image ranker: the technique for image search is adopted to the image ranking operation. Specifically, an inverted index is used that maps from each visterm feature in the test images to the images in the database containing that visterm. The IDF of found visterms in a candidate venue are averaged to get the venue score.

Mobility data ranker: This module computes the similarity based on visiting time (v), user activity (r), and stay duration (d) between each venue in the candidate list and the user test venue. The similarity is taken as the joint probability of the different mobility features at the candidate venue. In particular, the mobility similarity (m) between the current user mobility test data (v; r, and d) and a venue fingerprint (F) is given by:

m=p((v,r,d)|F)=p(F_{V}=v)·p(F_{R}=r)·p(F_{D}=d) (2)

where p(F_{V}=v) can be obtained from the histogram (i.e. the fingerprint) of the user visiting time at the candidate venue, p(F_{R}=r) from the histogram of the user activity, and p(F_{D}=d) from the histogram of stay duration.

This metric indicates that a candidate venue is good if it has a high probability of matching the current user mobility behavior.

For example, food venues would have close visiting time (e.g. at meals time), long stay durations (e.g. 30+ minutes), and similar user activity (e.g., sitting) with high probability.

Color/Light ranker: The color/light similarity is performed based on the Euclidean distance between their cluster centroids and the sizes of the clusters. The similarity (s) between fingerprints F₁ and F₂ is defined as:

$$s = {\sum }_{i , j} \frac{1}{δ ( i , j )} \frac{sizeof ( {C}_{1 i} )}{{T}_{1}} \frac{sizeof ( {C}_{2 j} )}{{T}_{2}} \qquad ( 3 )$$

where C₁ᵢ, C₂ⱼ are set of clusters for fingerprints F₁ and F₂ respectively. T₁, T₂ are the total number of pixels in clusters in F₁ and F₂ respectively, and δ(i,j) is the centroid distance between the i^{th} cluster of F₁ and the j^{th} cluster of F₂.

Popularity ranker: This module ranks more popular venues higher based on their popularity rate.

### Rank Aggregation

In rank aggregation module 108c, the present invention uses the Borda's order-based method which assigns a weight to each entity in the individual rankers lists based on its order in that list. That is, the last element in the list is assigned a weight of zero, then one, and so on. The candidates are ranked in decreasing order of the sum of their weights in the different lists.

### User Feedback

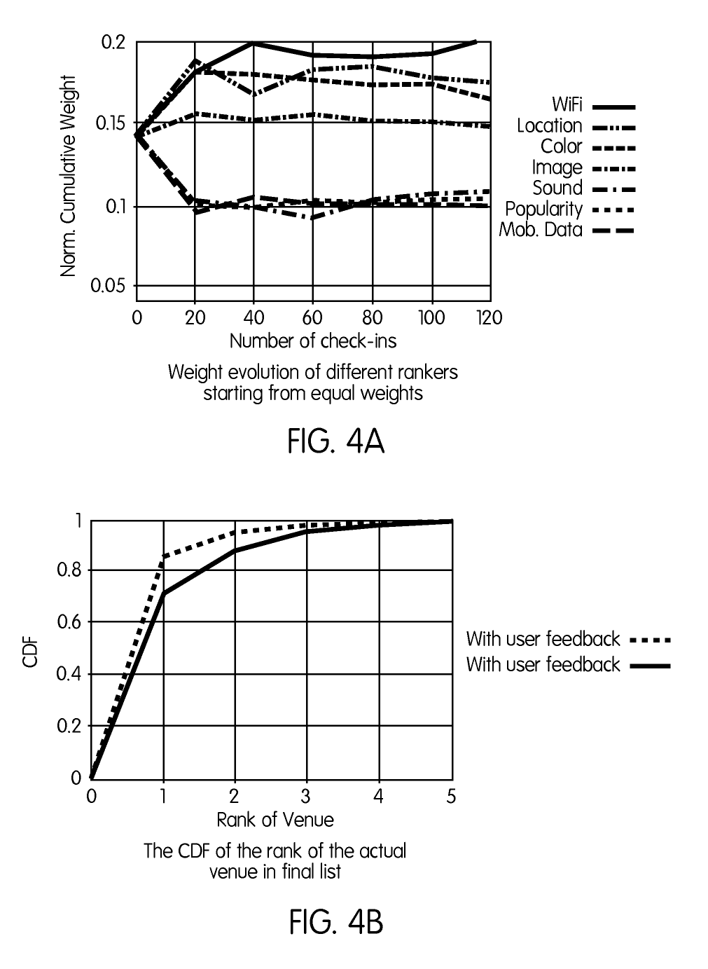

Referring to FIG. 4B, a significant characteristic of the users' interaction with a LBSN is that the user, in user feedback module 116, explicitly selects a venue to check-in from the list of nearby venues, which acts as the “ground truth” for the user current venue. This feedback not only provides information about the performance of the venue ranking algorithm, but it also can improve the system performance by identifying which ranker provides the best performance.

Specifically, as shown in FIG. 4A, user feedback is leveraged to weigh the different rankers. Initially, all rankers have an equal weight. After each check-in operation, and given that the candidate list contains 1 venues, each ranker is assigned a score of, l-i where i is the rank of the actual venue in the rankers' list.

These scores are then normalized to sum to one.

### Semantic Floorplan Labelling

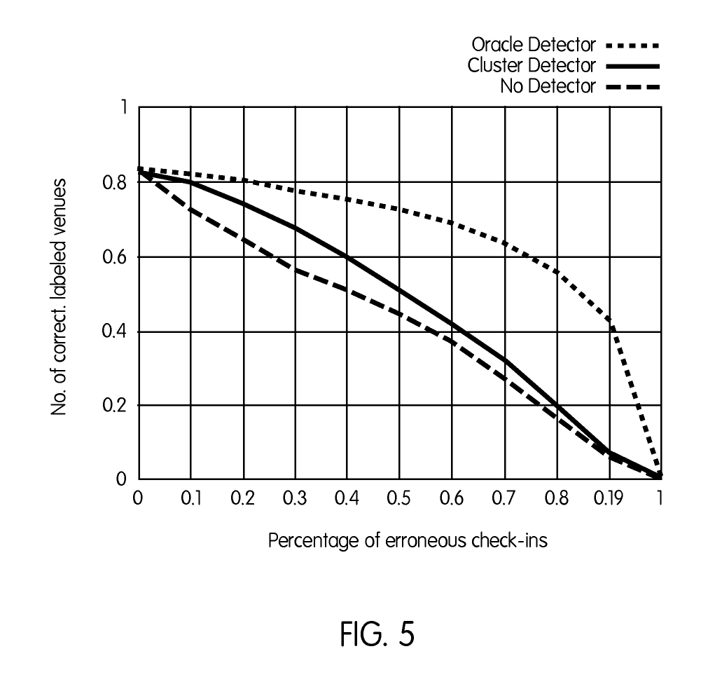

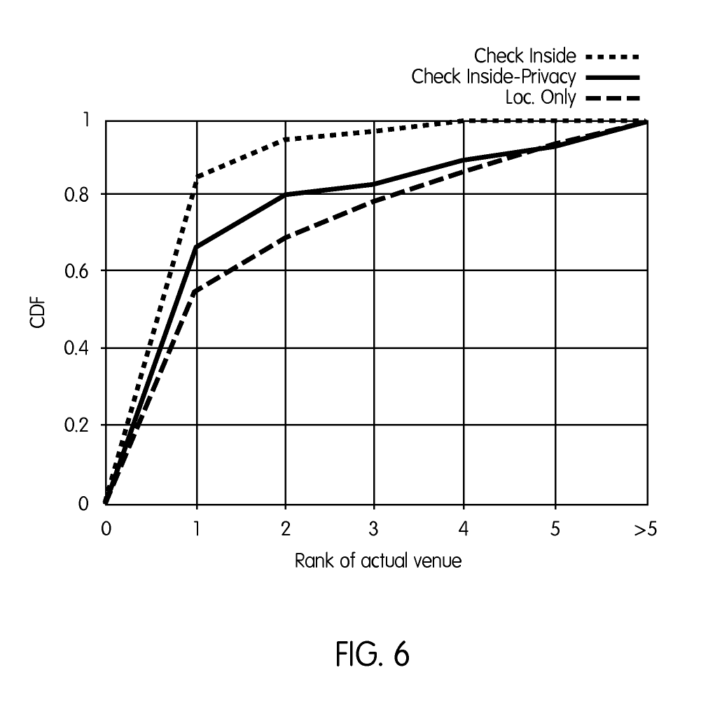

Referring to FIG. 5, the semantic floorplan labelling component 118 is responsible for the automatic labelling of the venue names on the floorplan. The system starts with a floorplan with shops and corridors highlighted which can be either manually uploaded or automatically generated from crowdsourced data. To enrich the floorplan with the semantic labels of the venue names, one cannot simply use the user check-in information, which provides the current venue name, and the current user location due to the errors inherent in the check-in process. In particular, the errors in the check-in process falls into two categories: (1) When users manually select a venue to check-in from the candidate list, they may select the wrong venue either intentionally (this captures the case when the user is not in the venue during the check-in process) or accidentally; and (2) The indoor localization algorithm employed has an error range, which may place the user at an incorrect venue, even if it is just a few meters.

To address these challenges, the system uses an unsupervised outlier detection algorithm as there is no a-priori model available for identifying correct assignments of a semantic label to a venue. Our approach is based on outliers detection in the WiFi signal space. Given the fact that independent correct check-ins made at the same venue are adjacent in the signal space and tend to cluster, an agglomerative hierarchical clustering approach to detect check-ins that are suspected to be erroneous is applied. Label assignment incorporates only those check-ins tagged as correct. The system maintains all locations assigned to a venue during check-in operations within a time window (regardless of correctness), so that all data can be used to periodically reclassify clusters and outliers for that venue.

For the agglomerative hierarchical clustering algorithm, clusters are successively merged in a bottom-up fashion, based on the WiFi similarity metric in Eq. 1, until the similarity falls below a pre-defined cut-off threshold d*. The selection of appropriate value for d* is based on formulating the threshold identification problem as a Bayesian decision problem.

When the system starts, it has not yet obtained enough check-ins and thus majority voting is not feasible. Therefore, the correct cluster of check-ins is identified c*ᵥ given a set of check-in clusters (cᵥ) at venue v according to the following criterion:

$${c}_{v}^{*} = {arg min}_{c ∈ {c}_{v}} {\sum }_{m ∈ N ( v )} {d}_{s} ( c , {c}_{m}^{*} ) \qquad ( 4 )$$

where _{N(v)} is the set of neighboring venues to venue v, c*ₘ is the cluster of correct check-ins at neighboring venue m at the time of computation, and dₛ(c,c*ₘ) is distance between the two clusters centroids. The intuition is that the correct cluster assignment for a venue is the one that is most similar to its neighboring venues.

Once the outliers are removed, the venue location is estimated as the mean of the locations of the users who check-in at this venue. Based on the law of large numbers, this mean converges to the actual location as the number of samples increases. The venue enclosing this location on the map is tagged accordingly.

We claim:

1. A system for providing a find-grained location-based service for a mobile computing platform comprising:
software, running on said mobile computing platform, said software performing the functions of:
determining if said mobile computing platform is stationary at a particular location;
sampling data collected from one or more sensors located on said mobile computing platform, in accordance with a privacy policy;
sending said sampled data to a server;
receiving, from said server, a list of one or more likely venues;
allowing a user to select a venue from said list of one or more venues and sending said selection to said server.

2. The system of claim 1 wherein said software performs the further function of collecting information from social media applications and sending said data to said server.

3. The system of claim 1 wherein said software only performs the step of sampling after it has been determined that said mobile computing platform has been stationary for a pre-determined period of time.

4. A system for providing a find-grained location-based service for a mobile computing platform having software, running on said mobile computing platform, said software comprising:
a sensor sampling module, for sampling data from one or more sensors built into said mobile computing platform and sending said sampled data to a server;
a privacy module, to allow user control which of said sampled data should be sent to said server; and
a fixed venue determination module, for determining f said mobile computing platform is stationary.

5. A server for identifying venues to a plurality of clients comprising:
software, running on said server, said software comprising:
a feature extraction module for extracting features from sensor data received from a client, said extracted feature being used to characterize a venue;
a fingerprint module, for preparing a fingerprint of a venue where said client is located, based on said extracted features;
a venue ranking module, for ranking a candidate list of venues;
a user feedback module, for receiving the selection of a venue from said client; and
a semantic floorplan labelling module, for automatic labeling of venue names on a floorplan.

6. The server of claim 5 further comprising:
a venues database, containing characteristics of known venues; and
a venues database manager, for selecting possible venues from said database and submitting said selected venues to said venue ranking module.

7. The server of claim 6 wherein said venue database manager uses said sensor data received form said client top select possible venues from said venues database.

8. The server of claim 5 wherein said extracted features characterize both the location and mobility of said client.

9. The server of claim 8 wherein said mobility of said client is characterized by client activity within a venue; time of day said venue is typically visited and the time clients typically spend is said venue.

10. The server of claim 5 wherein said fingerprint of said venue uses characteristics selected from a group consisting of mobility data, dominant color and light intensity, sound, images, WiFi connectivity and location.

11. The server of claim 5 wherein said venue ranking module ranks likely venues where said client is located based on filtering, feature-based ranking, and rank aggregation.

12. The server of claim 11 wherein said filtering is based on the current location of said client and the WiFi fingerprint from said fingerprint module.

13. The server of claim 11 wherein said feature-based ranking generates weighted lists of possible venues based on features selected from a group consisting of mobility data, dominant color and light intensity, sound, images, and popularity.

14. The server of claim 11 wherein said rank aggregation is based on a weighted ordering of possible venues depending upon the weight of each venue in in said weighted lists.

15. The server of claim 11 wherein said venues ranking module accepts a user-selected venue from said user feedback module and includes it in said list of ranked venues.

16. The server of claim 11 wherein said semantic floorplan labelling module obtains a floorplan containing one or more venues and labels said floorplan with the names of individual venues located thereon.

17. The server of claim 16 wherein said semantic floorplan labelling module uses an unsupervised outlier detection algorithm.

18. The server of claim 17 wherein said outlier detection algorithm detects outliers from a cluster of positively-identified client locations associated with a particular venue based on adjacency in the WiFi signal space.

19. The server of claim 18 wherein the location of a venue is estimated as the mean of the locations of all clients who checked-in identifying that venue.

20. The server of claim 16 wherein said floorplan is obtained by manually uploading or automatically generated from crowdsourced data.
